(19) United States
(12) Patent Application Publication
(10) Pub. No.: US 2012/0311709 A1
(43) Pub. Date: Dec. 6, 2012

(54) AUTOMATIC MANAGEMENT SYSTEM FOR GROUP AND MUTANT INFORMATION OF MALICIOUS CODES

(75) Inventors: Hong-Koo Kang, Uijeongbu-si (KR); Chae-Tae Im, Seoul (KR); Joo-Hyung Oh, Seoul (KR); Jong-Il Jeong, Seongnam-Si (KR); Jin-Kyung Lee, Seoul (KR); Byoung-Ik Kim, Seongnam-Si (KR); Hyun-Cheol Jeong, Seoul (KR); Seung-Goo Ji, Seoul (KR); Tai-Jin Lee, Seoul (KR)

(73) Assignee: KOREA INTERNET & SECURITY AGENCY, Seoul (KR)

(21) Appl. No.: 13/304,981

(22) Filed: Nov. 28, 2011

(30) Foreign Application Priority Data
Dec. 23, 2010 (KR) 10-2010-0133533

(51) Int. Cl. G06F 21/00

(52) U.S. Cl. 726/24

(57) ABSTRACT

An automatic management system includes a malicious code group-mutant storage module that receives a malicious codes analysis result from a malicious code collection-analysis system and extracts group information and mutant information of the malicious codes based on the malicious code analysis result, a malicious code group-mutant DB that stores the extracted group information and mutant information, a malicious code group-mutant management module that provides interface to allow a user to detect the group information and mutant information stored in the malicious code group-mutant DB, and a visualizing module that outputs the detection result to the user, wherein the malicious code group-mutant management module that groups malicious codes having action associations using the group information and mutant information stored in the malicious code group-mutant DB, outputs the group information through the visualizing module and outputs the mutant information based on CFG similarity and string similarity through the visualizing module.

### CROSS-REFERENCE TO RELATED APPLICATION

This application claims priority from Korean Patent Application No. 10-2010-133533 filed on Dec. 23, 2010 in the Korean Intellectual Property Office, the disclosure of which is incorporated herein by reference in its entirety.

### BACKGROUND OF THE INVENTION

1. Field of the Inventive Concept

The present invention relates to an automatic management system for group and mutant information of malicious codes.

2. Description of the Related Art

Malicious code is a set of various types of malicious or abusable software and is a general term for the software that may become potential hazards to users and computers, such as viruses, worms, spyware, malicious adware or the like. In the dictionary definition, the malware (known also as ‘malicious software’) is software programmed to carry out a malicious action such as intentionally disrupting a system or leaking private information against an interest or intension of a user. The malware is translated into ‘malicious codes’ and may comprise viruses capable of self replication or file infections in a broader sense.

The malicious codes may be grouped into different groups according to action association, and mutant information of the malicious codes may also be identified. The grouping and identifying mutant information may provide many implications in handling the malicious codes.

### SUMMARY

The present invention provides an automatic management system for group and mutant information of malicious codes, which can systematically analyze and manage group information and mutant information of the malicious codes.

The above and other objects of the present invention will be described in or be apparent from the following description of the preferred embodiments.

According to an aspect of the present invention, there is provided an automatic management system for group and mutant information of malicious codes, the automatic management system including a malicious code group-mutant storage module that receives a malicious codes analysis result from a malicious code collection-analysis system and extracts group information and mutant information of the malicious codes based on the malicious code analysis result, a malicious code group-mutant database (DB) that stores the extracted group information and mutant information, a malicious code group-mutant management module that provides interface to allow a user to detect the group information and mutant information stored in the malicious code group-mutant DB, and a visualizing module that outputs the detection result to the user, wherein the malicious code group-mutant management module that groups malicious codes having action associations using the group information and mutant information stored in the malicious code group-mutant DB, outputs the group information through the visualizing module and outputs the mutant information based on CFG (Control Flow Graph) similarity and string similarity through the visualizing module.

In the automatic management system for group and mutant information of malicious codes according to one embodiment of the present invention, malicious codes having an action association for a particular malicious code are grouped and managed, and mutants of the particular malicious code are systematically managed according to similarity. A user of the system according to the present invention can rapidly grasp group information on malicious codes associated with the particular malicious code and information on mutants of the particular malicious code. Therefore, it is possible to systematically and effectively cope with malicious codes that are becoming diversified more and more.

### BRIEF DESCRIPTION OF THE DRAWINGS

The above and other features and advantages of the present invention will become more apparent by describing in detail preferred embodiments thereof with reference to the attached drawings in which:

FIG. 1 is a block diagram of an automatic management system for group and mutant information of malicious codes according to an embodiment of the present invention;

FIGS. 2 and 3 illustrate associations between malicious code group-mutant DB tables in the automatic management system for group and mutant information of malicious codes shown in FIG. 1;

FIG. 4 is a flowchart illustrating an operation of detecting a malicious code group in the automatic management system for group and mutant information of malicious codes shown in FIG. 1;

FIG. 5 illustrates an example of an output screen showing a result of malicious code group detection of FIG. 4;

FIG. 6 is a flowchart illustrating an operation of detecting mutant information by malicious code group-mutant management module in the automatic management system for group and mutant information of malicious codes shown in FIG. 1; and

FIG. 7 illustrates an example of an output screen showing a result of malicious code group detection of FIG. 6.

### DETAILED DESCRIPTION OF THE INVENTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. The same reference numbers indicate the same components throughout the specification. In the attached figures, the thickness of layers and regions is exaggerated for clarity.

Unless defined otherwise, all technical and scientific terms used herein have the same meaning as commonly understood by one of ordinary skill in the art to which this invention belongs. It is noted that the use of any and all examples, or exemplary terms provided herein is intended merely to better illuminate the invention and is not a limitation on the scope of the invention unless otherwise specified. Further, unless defined otherwise, all terms defined in generally used dictionaries may not be overly interpreted.

Hereinafter, an automatic management system for group and mutant information of malicious codes according to an embodiment of the present invention will be described in further detail with reference to the accompanying drawings.

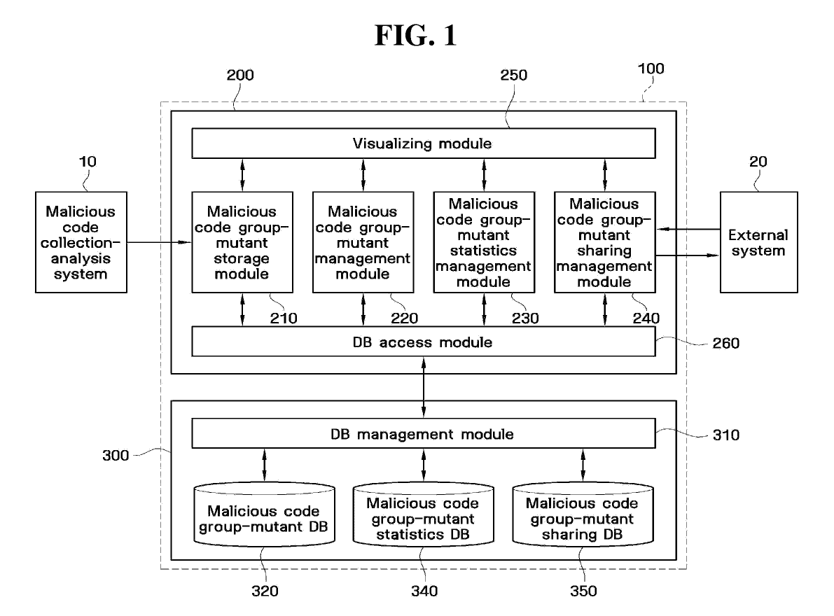

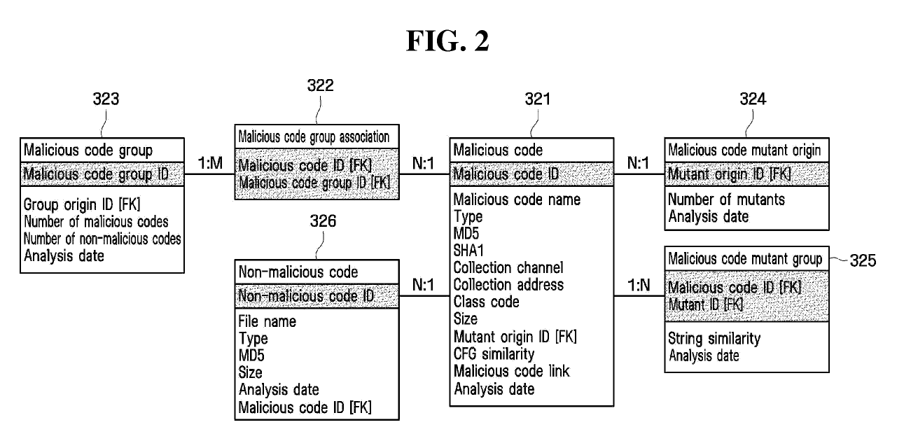

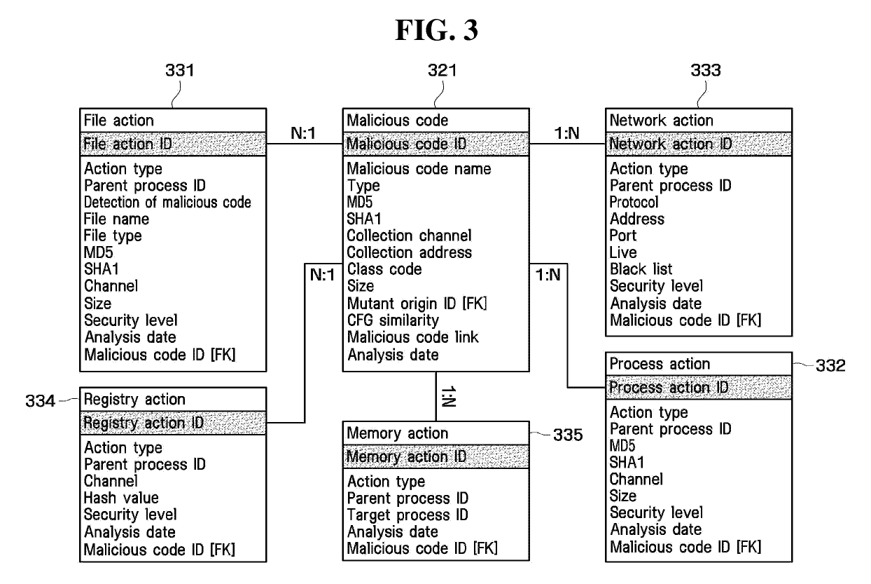

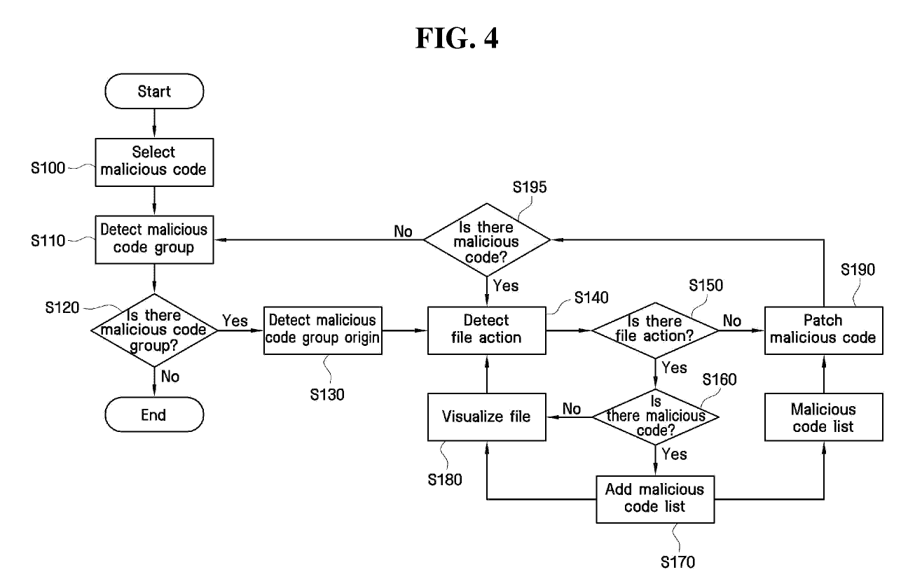

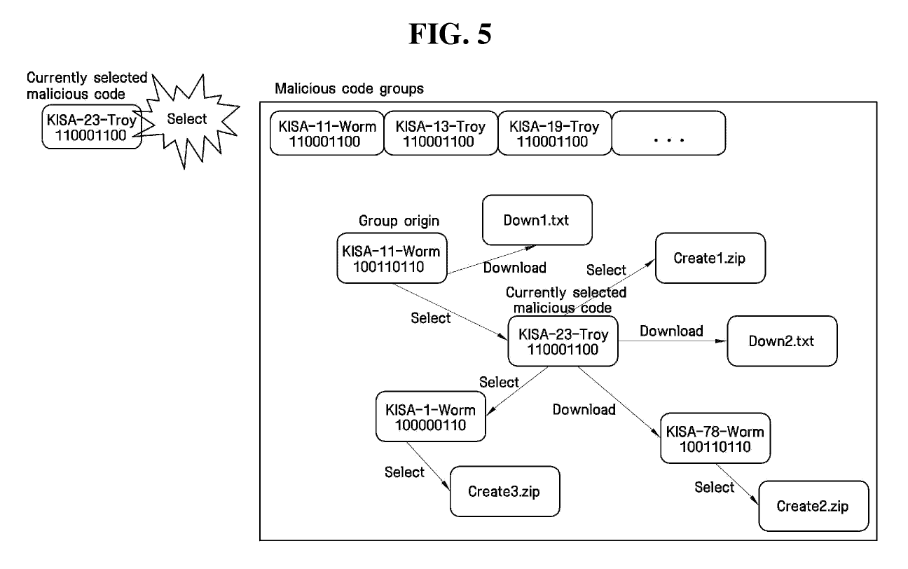

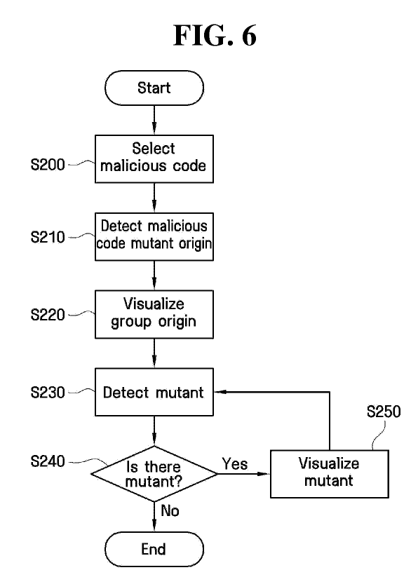

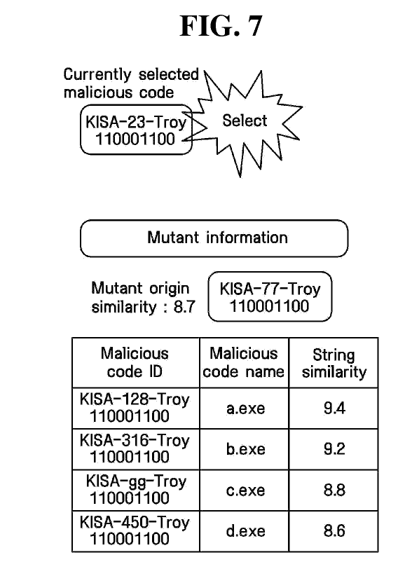

FIG. 1 is a block diagram of an automatic management system for group and mutant information of malicious codes according to an embodiment of the present invention, FIGS. 2 and 3 illustrate associations between malicious code group-mutant DB tables in the automatic management system for group and mutant information of malicious codes shown in FIG. 1, FIG. 4 is a flowchart illustrating an operation of detecting a malicious code group in the automatic management system for group and mutant information of malicious codes shown in FIG. 1, FIG. 5 illustrates an example of an output screen showing a result of malicious code group detection of FIG. 4, FIG. 6 is a flowchart illustrating an operation of detecting mutant information by a malicious code group-mutant management module in the automatic management system for group and mutant information of malicious codes shown in FIG. 1, and FIG. 7 illustrates an example of an output screen showing a result of malicious code group detection of FIG. 6.

Referring to FIG. 1, the automatic management system 100 for group and mutant information of malicious codes according to an embodiment of the present invention includes an application server 200 and a database (DB) server 300. Here, the application server 200 may include a malicious code group-mutant storage module 210, a malicious code group-mutant management module 220, a malicious code group-mutant statistics management module 230, a malicious code group-mutant sharing management module 240, a visualizing module 250 and a DB access module 260. The DB server 300 may include a DB management module 310, a malicious code group-mutant DB 320, a malicious code group-mutant statistics DB 340, and a malicious code group-mutant sharing DB 350.

The malicious code group-mutant storage module 210 may be a module that receives a malicious code analysis result from the malicious code collection-analysis system 10 and extracts malicious code group information and mutant information based on the malicious code analysis result. In detail, the malicious code group-mutant storage module 210 receives the malicious code analysis result from the malicious code collection-analysis system 10 supplied in the form of XML (Extensible Markup Language) file that can be easily shared through a web, extracts malicious code group information and mutant information from the malicious code analysis result, and stores the same in the malicious code group-mutant DB 320 through the DB access module 260 and the DB management module 310. Although not shown in FIG. 1, the malicious code group-mutant storage module 210 may further include a separate temporary buffer (not shown) for facilitating the extraction and storage.

Here, the malicious code group-mutant DB 320 may serve as a storage place for storing the extracted malicious code group information and mutant information. In the automatic management system 100 for group and mutant information of malicious codes according to an embodiment of the present invention, the malicious code group-mutant DB 320 may include various tables shown in FIGS. 2 and 3.

First, referring to FIG. 2, the malicious code group-mutant DB 320 has a malicious code table 321, a malicious code group association table 322, a malicious code group table 323, a malicious code mutant origin table 324, a malicious code mutant group table 325, and a non-malicious code table 326.

The malicious code table 321 has a malicious code ID as a key value, and stores information regarding malicious codes. The malicious code table 321 has various fields including malicious code name, type, hash value, collection channel, collection address, class code, analysis date, size, mutant origin ID, CFG (Control Flow Graph) similarity, malicious code link, and so on. Here, the “malicious code name” field indicates a name of a malicious code diagnosed. The “type” field indicates a malicious code file type to specify whether the malicious code file is based on, for example, PDF, Script, or Text. The “hash value” field indicates hash values obtained for the entire file using a hash function such as MD5 or SHA1. The “collection channel” field indicates a channel from which the malicious code is collected, to specify whether the malicious code is collected from, for example, a spam mail or a web. The “collection address” field indicates an URL address for the collection channel, and the “analysis code” field contains information regarding intrinsic code values for analyzing malicious codes. The “analysis date” field indicates an execution date of analyzing malicious codes. The “size” field indicates malicious code size information. The “mutant origin ID” field indicates an ID of a most similar malicious code as a result of measuring similarities of malicious code commands measured using input malicious codes and CFG (Control Flow Graph). The “CFG similarity” field indicates a CFG analysis result. Finally, the “malicious code link” field indicates an address of a storage place from which a malicious code can be downloaded.

The malicious code group association table 322 is a table that establishes association between the malicious code table 321 and the malicious code group table 323, and contains malicious code ID and malicious code group ID as key values. A malicious code may belong to multiple malicious code groups. Thus, the malicious code group association table 322 and the malicious code table 321 have an N:1 relationship. The malicious code group association table 322 may be omitted when the malicious code table 321 and the malicious code group table 323 are directly connected to each other.

The malicious code group table 323 contains a malicious code group ID as a key value and means a set of malicious codes having action associations. The malicious code group table 323 has various fields including group origin ID, number of malicious codes, number of non-malicious codes, analysis date, and so on. The “group origin ID” field indicates ID of a malicious code that performs the most significant action among actions associated. The “number of malicious codes” filed indicates the number of malicious codes included in a malicious code group. The “number of non-malicious codes” field indicates the number of non-malicious codes included in a malicious code group. The various fields of the malicious code group table 323 will later be described in further detail when describing the operation of the malicious code group-mutant management module 220. The malicious code group table 323 and the malicious code group association table 322 may have a 1:M relationship. Consequently, the malicious code group table 323 and the malicious code table 321 may have an M:N relationship.

The malicious code mutant origin table 324 has a mutant origin ID as a key value. The malicious code mutant origin table 324 is a table that stores information regarding malicious code mutants similar to a mutant origin. The malicious code mutant origin table 324 has various fields including number of mutants, analysis date, and so on. Here, the “number of mutants” field indicates the number of mutants similar to the mutant origin. The “analysis date” field indicates an execution date of analyzing malicious code mutants. There may be multiple malicious codes similar to a mutant origin. Thus, the malicious code mutant origin table 324 and the malicious code table 321 may have a 1:N relationship.

The malicious code mutant group table 325 has IDs of malicious code mutants. In addition, the malicious code mutant group table 325 is a table that stores string similarity between malicious code mutants. The malicious code mutant group table 325 has fields of string similarity and analysis date. As described above, the “string similarity” field indicates similarity between malicious code mutants, assessed in view of string (that is, in view of arranged text string pattern). The “analysis date” field indicates an execution date of analyzing string similarity of malicious code mutants. The string similarity can be assessed between one malicious code and multiple mutants thereof. The malicious code mutant group table 325 and the malicious code table 321 may have an N:1 relationship.

The non-malicious code table 326 has non-malicious code ID as a key value. In addition, the non-malicious code table 326 is a table that stores information regarding a general file, instead of information regarding malicious codes. The non-malicious code table 326 has various fields including file name, type, hash value, size, analysis date, and malicious code ID. The “file name” field, the “type” field, the “hash value” field, the “size” field, and the “analysis date” field are substantially the same as those described above, and detailed descriptions thereof will be omitted. The “malicious code ID” field indicates ID of a malicious code having action association with a currently selected non-malicious code (i.e., a general file). For example, if a malicious code denoted by “A” has an action feature of downloading a general file that is not malicious code (e.g., Down2.txt), the malicious code A is stored in the “malicious code ID” field of the general file, e.g., Down2.txt. A malicious code may have action associations with multiple general files. The non-malicious code table 326 and the malicious code table 321 may have an N:1 relationship.

Referring to FIG. 3, the malicious code group-mutant DB 320 may include malicious code action association tables. The malicious code action association tables store information regarding malicious code actions. For example, as shown in FIG. 3, the malicious code action association tables may include a file action table 331, a process action table 332, a network action table 333, a registry action table 334, and a memory action table 335. The respective tables 331 to 335 may have fields that store various action features and different malicious code ID fields for performing various actions. For example, if a malicious code denoted by “B” has an action feature of downloading a malicious code denoted by “C”, the malicious code C is stored in another “malicious code ID” field associated with a file action of the malicious code B. One malicious code may have various action features, and the malicious code action association table and the malicious code table 321 may have an N:1 relationship.

Referring back to FIG. 1, the malicious code group-mutant management module 220 is a module that provides interface to allow a user to detect the group information and mutant information of the malicious codes stored in the malicious code group-mutant DB 320.

In detail, when the user detects group information of a particular malicious code, the malicious code group-mutant management module 220 groups the malicious codes having action associations with the particular malicious code from the group information and mutant information stored in the malicious code group-mutant DB 320, and outputs the grouped malicious codes through the visualizing module 250.

The operation of the malicious code group-mutant management module 220 will now be described with reference to FIGS. 4 and 5.

Referring to FIGS. 4 and 5, a malicious code to be detected is selected (S100). In addition, a malicious code group having action association is detected for the selected malicious code (S110). Here, the malicious code table 321, the malicious code group association table 322 and the malicious code group table 323 of the malicious code group-mutant DB 320 may be used.

If there is a malicious code group, a malicious code group origin is detected (S130). If the malicious code group origin is detected, a file action of the malicious code group origin is detected using the action association table of the malicious code group origin (S140). As a result, if the malicious code group origin is associated with another malicious code through an action (for example, downloading or generating another malicious code, etc.), the associated new malicious code is added to a malicious code list, which is then output to a user through the visualizing module 250, as shown in FIG. 5 (S150˜S180). If the malicious code group origin is associated with another file through an action but the associated file is not a malicious code, the associated file is not added to the malicious code list but is output to the user through the visualizing module 250 (S150, S160, S180). If the outputting of the file is completed, it is further detected whether there is a malicious code and a general file associated with another action (S140).

Referring to FIG. 5, a malicious code group origin, e.g., KISA-11-Worm 100110110, has action-association with Down1.txt and KISA-23-Troy 110001100. Here, since Down1.txt is a general file, not a malicious code, it is not added to the malicious code list but is immediately output. Since KISA-23-Troy 110001100 is a malicious code, it is added to the malicious code list and then output.

Referring back to FIG. 4, if there is no more action-associated malicious code of the malicious code group origin, the malicious codes stored in the malicious code list are patched (S190). As a result, if there is a malicious code, it is repeatedly detected whether there is a malicious code having action association (S195). That is to say, as shown in an example of FIG. 5, after detecting whether action-associated malicious code of the malicious code group origin, i.e., KISA-11-Worm 100110110, is completed, the same process as the malicious code group origin, i.e., KISA-11-Worm 100110110, is repeatedly performed on KISA-23-Troy 110001100 in the malicious code list.

If there is no more malicious code in the malicious code list, another malicious code group is detected (S195, S110). As described above, a malicious code to be detected may belong to various groups having action associations. Thus, all groups to which the malicious code to be detected belongs are detected and then output, as shown in FIG. 5. As a result, if no more group to which the malicious code belongs is detected, detecting of the group information is completed.

Next, when a user detects mutant information of a particular malicious code, the malicious code group-mutant management module 220 detects a mutant origin and mutants of the malicious code to be detected from the malicious code group information and malicious code mutant information stored in the malicious code group-mutant DB 320, and outputs the malicious code mutants through the visualizing module 250 based on string similarity. The operation of the malicious code group-mutant management module 220 will now be described with reference to FIGS. 6 and 7.

Referring to FIGS. 6 and 7, a malicious code to be detected is selected (S200). Then, a mutant origin for the selected malicious code is detected (S210). Here, the aforementioned mutant origin table 324 may be used.

If the mutant origin is detected, the detected mutant origin is output through the visualizing module 250, as shown in FIG. 7. As described above, the mutant origin may be a most similar malicious code as a result of measuring similarities of malicious code commands using the malicious codes of which the mutant information is detected by the user and CFG (Control Flow Graph).

Next, mutants of the malicious code to be detected are detected (S230). Here, the aforementioned mutant group table 325 may be used. As a result, if the malicious code mutants are detected, the malicious code mutants are output through the visualizing module 250, as shown in FIG. 7 (S240, S250). Here, the malicious code mutants may be output in order of string similarity. If there is no mutant of the malicious code detected in the mutant group table 325, detecting of mutant information is completed.

Referring back to FIG. 1, the malicious code group-mutant statistics management module 230 may be a module that generates statistic data for the group information and mutant information stored in the malicious code group-mutant DB 320. The generated statistic data may be stored in the malicious code group-mutant statistics DB 340. Meanwhile, the malicious code group-mutant statistics management module 230 may provide a user with the generated statistic data through the visualizing module 250.

The malicious code group-mutant sharing management module 240 may be a module that receives a request for sharing the group information and mutant information of the malicious codes from the external system 20, stores the group information and mutant information stored in the malicious code malicious code group-mutant DB 320 in the malicious code group-mutant sharing DB 350 in response to the request, and transmits the same to the external system 20. It is quite important to share the information regarding the malicious codes with external system in view of prevention and measurement of malicious code damages and accidents. To this end, in the automatic management system for group and mutant information of malicious codes according to an embodiment of the present invention, the malicious code group-mutant sharing management module 240 is separately provided. As described above, the group information and mutant information of the malicious code transmitted to the external system 20 are transmitted in the form of XML files that can be easily shared through a web. Thus, action associations among malicious codes can be easily apprehended and the mutant information can be rapidly recognized, it is possible to efficiently cope with the malicious codes.

The visualizing module 250 is a module that visualizes information provided to the user. Specifically, the visualizing module 250 may visualize and output the group information and mutant information detected by the user from the malicious code group-mutant management module 220 the statistic data generated by the malicious code group-mutant statistics management module 230, and the information shared by the malicious code group-mutant sharing management module 240 and the external system 20 so as to allow the user to easily recognize the same. That is to say, as shown in FIGS. 5 and 7, in order for the user to grasp the group information and mutant information detected by the user at a glance, the visualizing module 250 may have a variety of graphic user interfaces (GUIs).

The DB access module 260 of the application server 200, together with the DB management module 350, is used for storage, detection, deletion and updating of the information stored in various DBs 320, 340 and 350 of the DB server 300. That is to say, the DB access module 260 and the DB management module 350 generate and process various transactions associated with information storage, detection, deletion and updating.

As described above, in the automatic management system 100 for group and mutant information of malicious codes according to an embodiment of the present invention, malicious codes having action-association for a particular malicious code are grouped and managed, and mutants of the particular malicious code are systematically managed according to the similarity. Therefore, a user of the system according to the present invention can rapidly grasp group information on malicious codes associated with the particular malicious code and information on mutants of the particular malicious code. Therefore, it is possible to systematically and effectively cope with malicious codes that are becoming diversified more and more.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. An automatic management system for group and mutant information of malicious codes, the automatic management system comprising:
a malicious code group-mutant storage module that receives a malicious codes analysis result from a malicious code collection-analysis system and extracts group information and mutant information of the malicious codes based on the malicious code analysis result;
a malicious code group-mutant database (DB) that stores the extracted group information and mutant information;
a malicious code group-mutant management module that provides interface to allow a user to detect the group information and mutant information stored in the malicious code group-mutant DB; and
a visualizing module that outputs the detection result to the user,
wherein the malicious code group-mutant management module that groups malicious codes having action associations using the group information and mutant information stored in the malicious code group-mutant DB, outputs the group information through the visualizing module and outputs the mutant information based on CFG (Control Flow Graph) similarity and string similarity through the visualizing module.

2. The automatic management system of claim 1, wherein the malicious code group-mutant DB includes a malicious code table, a malicious code group table, a malicious code action association table, and a mutant group table.

3. The automatic management system of claim 2, wherein the malicious code group-mutant management module detects from the malicious code table a group to which the malicious codes belong when the user detects the group information, detects a malicious code group origin from the malicious code group table corresponding to the group, detects all malicious codes having action associations with the malicious code group origin using the malicious code action association table, and outputs the detection result through the visualizing module.

4. The automatic management system of claim 2, wherein, the malicious code group-mutant management module detects a mutant origin for the malicious code from the malicious code table when the user detects the mutant information of the malicious code, outputs the malicious code mutant origin through the visualizing module, detects malicious code mutants from the mutant group table, and outputs the detected malicious code mutants through the visualizing module, and wherein the malicious code mutants are output in an order of string similarity.

5. The automatic management system of claim 4, wherein the malicious code mutant origin includes a malicious code of which the mutant information is detected by the user, and a most similar malicious code as a result of measuring similarities of malicious code commands using input malicious codes and CFG (Control Flow Graph).

6. The automatic management system of claim 1, wherein the malicious code analysis result supplied from the malicious code collection-analysis system is supplied in the form of XML (Extensible Markup Language) file.

7. The automatic management system of claim 1, further comprising:
a malicious code group-mutant statistics management module that generates statistic data for the group information and the mutant information stored in the malicious code group-mutant DB; and
a malicious code group-mutant sharing management module that receives a request for sharing the group information and the mutant information of the malicious code from the external system, and transmitting the group information and the mutant information stored in the malicious code group-mutant DB to the external system in response to the request.

8. The automatic management system of claim 7, wherein the group information and the mutant information stored in the malicious code group-mutant DB is transmitted to the external system in the form of XML file.
